(19) United States
(12) Patent Application Publication
(10) Pub. No.: US 2022/0127786 A1
(43) Pub. Date: Apr. 28, 2022

(54) PRINTABLE FABRIC MEDIA

(71) Applicant: Hewlett-Packard Development Company, L.P., Spring, TX (US)

(72) Inventors: Xiaoqi ZHOU, San Diego, CA (US); Or BRANDSTEIN, San Diego, CA (US)

(73) Assignee: Hewlett-Packard Development Company, L.P., Spring, TX (US)

(21) Appl. No.: 17/430,522

(22) PCT Filed: Dec. 20, 2019
(86) PCT No.: PCT/US2019/067959

§ 371 Date: Aug. 12, 2021

(51) Int. Cl. D06P 5/00; D06P 1/52; D06P 1/54; D06P 1/673; D06P 5/20; B41M 5/00; B41M 7/00; B41M 5/52

(52) U.S. Cl. CPC D06P 5/002; D06P 1/5292; D06P 1/5221; D06P 1/54; D06P 1/673; B41M 5/5263; D06P 5/2055; B41M 5/0017; B41M 7/009; B41M 5/5254; D06P 5/2066

(57) ABSTRACT

A printable fabric medium can include a fabric substrate and a polymeric particle blend including polysiloxane particles and polyolefin release particles pre-treated on the fabric substrate. A weight ratio of the polysiloxane particles to polyolefin release particles can be from 1:5 to 4:1, for example.

### BACKGROUND

Textile printing methods often include rotary and/or flat-screen printing, often including the creation of a plate or a screen. Both of these analog types of printing can have great throughput capacity but may have size limitations and initial setup that involves creating a screen, for example. Inkjet printing, on the other hand, is a non-impact printing method that utilizes electronic signals to control and direct droplets or a stream of ink to be deposited on media. Thus, with digital printing, if white ink compositions or related fluid sets can be prepared that have similar properties, e.g., durability, image quality, etc. as the more conventional fabric printing analog methods, users could benefit from enhanced printing flexibility, e.g., wider size ranges printed more immediately from an electronic image, with similar durability and image quality.

### BRIEF DESCRIPTION OF THE DRAWINGS

FIG. 1 schematically illustrates an example polymeric particle blend including polysiloxane particles and polyolefin release particles pre-treated on a fabric substrate;

FIG. 2 schematically illustrates an example printing system for printing white images on fabric substrates in accordance with the present disclosure;

FIG. 3 is a flow diagram illustrating an example method of printing white images on fabric substrates in accordance with the present disclosure;

FIG. 4 is a schematic diagram of an example of method of printing white images on fabric substrates using the example printing system shown in FIG. 2 and an example printing system, in accordance with the present disclosure;

FIG. 5 is an example graph illustrating the impact on hydrophobicity retention after machine washing in relation to the content of polyolefin release particles included in addition to polysiloxane particles also included in accordance with the present disclosure; and

FIG. 6 is an example graph illustrating the impact on L* of printed white ink composition and crosslinker composition on a pre-treated fabric substrate both before and after machine washing in accordance with the present disclosure.

### DETAILED DESCRIPTION

The textile market is a major industry, and printing on textiles, such as cotton, etc., has been evolving to include digital printing methods. Some digital printing methods enable direct to garment (or other textile) printing. White ink is a heavily used ink in direct to garment printing. Obtaining white images with good opacity, however, may be challenging, in part because of fibrillation, e.g., hair-like fibers sticking out of the fabric surface and interference of film-formation of white ink layers. To control fibrillation and improve film-forming of the white ink layers to achieve a suitable opacity of a white image on a colored garment, in accordance with the present disclosure, a pre-treatment composition can be applied to a fabric substrate to for a pre-treated printable fabric, and in further examples, a printing system and methods can utilize the pre-treated printable fabric by application of crosslinker composition and white ink composition thereon.

In accordance with this, the present disclosure is drawn to a printable fabric medium that includes a fabric substrate and a polymeric particle blend including polysiloxane particles and polyolefin release particles pre-treated on the fabric substrate. The weight ratio of the polysiloxane particles to polyolefin release particles in this example is from 1:5 to 4:1. In one example, the polysiloxane particles can include an amino-functionalized polysiloxane, a polymethylhydrosiloxane, a hydromethyl polysiloxane, a dimethyl polysiloxane, a hydromethyl-dimethyl polysiloxane, a polyhexamethyl disiloxane, a polyecamethyl tetrasiloxane, a polydodecamethyl pentasiloxane, a polyoctamethyl trisiloxane, a polyoctamethyl cyclotetrasiloxane, a polydodecamethyl cyclohexasiloxane, a polydecamethyl cyclopentasiloxane, or a combination thereof. In another example, the polyolefin release particles can include a polyethylene wax, a polypropylene wax, a copolymer of ethylene and propylene, a copolymer of ethylene and propylene with C4 to C8 alpha-olefin sidechains, or a combination thereof. The printable fabric can also include a fixer compound including an inorganic metal salt, an organic acid salt, an ionene salt, or a combination thereof. The fabric substrate can be, for example, a dark fabric having an L* value from 0 to 50.

In another example, a textile printing system includes a fabric substrate, a polymeric particle blend either pre-treated on the fabric substrate or contained in a pre-treatment composition applyable to the fabric substrate, a crosslinker composition including a crosslinker compound, and a white ink composition including a white pigment, a polymer binder, and an ink vehicle. The polymeric particle blend in this example includes polysiloxane particles and polyolefin release particles. The polysiloxane particles can include an amino-functionalized polysiloxane, a polymethylhydrosiloxane, a hydromethyl polysiloxane, a dimethyl polysiloxane, a hydromethyl-dimethyl polysiloxane, a polyhexamethyl disiloxane, a polyecamethyl tetrasiloxane, a polydodecamethyl pentasiloxane, a polyoctamethyl trisiloxane, a polyoctamethyl cyclotetrasiloxane, a polydodecamethyl cyclohexasiloxane, a polydecamethyl cyclopentasiloxane, or a combination thereof. The polyolefin release particles can include a polyethylene wax, a polypropylene wax, a copolymer of ethylene and propylene, a copolymer of ethylene and propylene with C4 to C8 alpha-olefin sidechains, or a combination thereof. The crosslinker compound in one example can be, for example, an azetidinium-containing polymeric salt. The white pigment can include titanium dioxide, zinc oxide, zirconium dioxide, cerium oxide, or a combination thereof, and is present in the white ink composition at from 4 wt % to 15 wt %. The fabric substrate can be a dark fabric having an L* value from 0 to 50.

A textile printing method in this example includes applying a crosslinker composition including a crosslinker compound to a fabric substrate that is pre-treated with a polymeric particle blend including polysiloxane particles and polyolefin release particles; digitally printing a white ink composition on the fabric substrate in contact with the crosslinker composition and the polymeric particle blend; and thermally curing the fabric substrate with the polymeric particle blend, the crosslinker composition, and the white ink composition in contact thereon to form a cured white image on the fabric substrate. The white ink in this example includes a white pigment, a polymer binder, and an ink vehicle. In one example, the polymeric particle blend can be applied to the fabric substrate by applying a pre-treatment composition containing the polymeric particle blend to the fabric substrate. In this example, the pre-treatment composition can be applied prior to application of the crosslinker composition and the white ink composition to the fabric substrate. In another example, the method can include applying heat, pressure, or both to the pre-treatment composition on the fabric substrate prior to application of the crosslinker composition and the white ink composition; applying heat, pressure, or both to the crosslinking composition on the fabric substrate prior to application of the white ink composition; or both. The method can also include applying multiple alternating layers of the crosslinker composition and white ink composition are applied to the fabric substrate in one example.

It is noted that when discussing the printable fabric media, the textile printing systems, and the methods herein, these various discussions can be considered applicable to these various examples, whether or not they are explicitly discussed in the context of that example. Thus, for example, in describing polysiloxane particles in the context of the printable fabric media, the polysiloxane particles particle descriptions are also applicable to the textile printing systems and method examples, and vice versa.

Furthermore, features of examples of the present disclosure will become apparent by reference to the detailed description herein, including the drawings, in which like reference numerals correspond to similar, though perhaps not identical, components. For the sake of brevity, reference numerals or features having a previously described function may or may not be described in connection with other drawings in which they appear.

### Printable Fabric Media

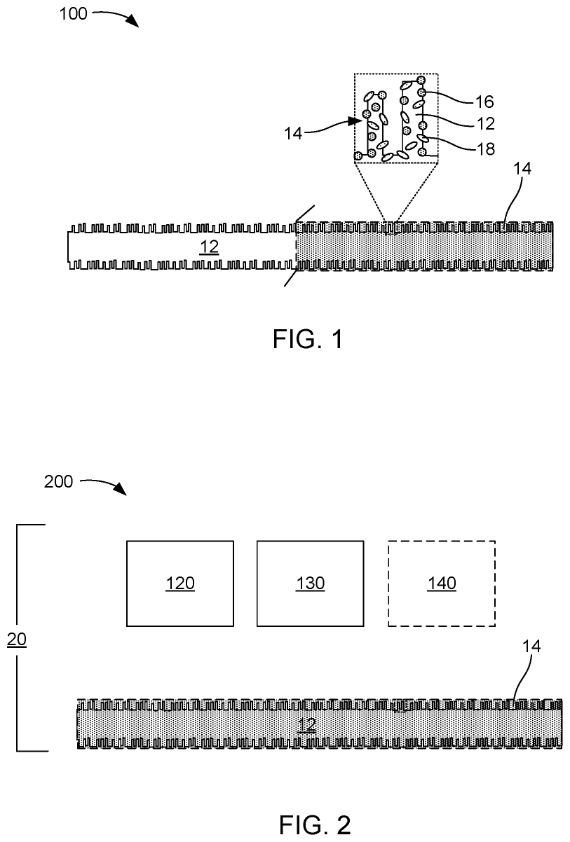

As shown in FIG. 1, a printable fabric medium 100 is shown. The printable fabric medium includes a fabric substrate 12 and a polymeric particle blend 14 including polysiloxane particles 16 and polyolefin release particles 18 pre-treated on the fabric substrate. In examples of the present disclosure, the fabric substrate can have an L* value from 0 to 50. L* values can be measured in the CIELAB color space and may be measured using any suitable color measurement instrument (such as those available from HunterLab or X-Rite). L* values that are high on a scale of 0 to 100 would white or near-white, and L* values that are low may be dark colors or black, for example. Thus, a dark fabric substrate would have low L* value and a white printed ink with good opacity on the dark fabric substrate would have a high L* value. In further detail, the polymeric particle blend can be included with the fabric substrate (applied to fibers, impregnated within fabrics, contained between fiber yarns, etc.) having a weight ratio of polymer polysiloxane particles to polyolefin release particles is from 1:5 to 4:1, from 1:5 to 3:1, from 1:4 to 4:1, or from 1:3 to 3:1. Notably in FIG. 1, only half of the fabric substrate is shown as being associated with the polymeric particle blend. This was done for clarity to illustrate the fabric substrate separately from the polymeric particle blend since in this example, the polymeric particle blend may be impregnated within the fabric substrate and/or applied on a surface of the fabric substrate or individual fabric substrate fibers.

### Textile Printing Systems

As shown in FIG. 2, a textile printing system 200 is shown that includes the fabric substrate 12 and the polymeric particle blend 14, as shown and described in FIG. 1, which is pre-treated on the fabric substrate. In examples of the present disclosure, as mentioned, the polymeric particle blend can include the polysiloxane particles as well as the polyolefin release particles. The fabric substrate can have an L* value from 0 to 50, and in further detail, can have a weight ratio of polymer polysiloxane particles to polyolefin release particles is from 1:5 to 4:1, in some examples. Additionally, part of the textile printing system 200 of this example can include a fluid set that can include a crosslinker composition 120 including a dispersion of a crosslinker compound in a crosslinker liquid vehicle, and white ink composition 130 that includes a white pigment, a polymer binder, and an ink vehicle. In one example, a pre-treatment composition 140 can be used to apply the polymeric particle blend to the fabric substrate analog application, e.g., spraying, dipping, soaking, padding, etc. The polymeric particle blend and the pre-treatment composition are both shown with dashed lines to indicate that the textile printing system includes either the fabric substrate treated with the polymeric particle blend, or alternatively can include a pre-treatment fluid for application of the polymeric particle blend. The crosslinker composition and/or a white ink composition that are formulated for inkjet printing, e.g., thermal and/or piezo inkjet printing, or the crosslinker composition can be applied by an analog application process and the white ink composition can be formulated for inkjet application, e.g., thermal and/or piezo inkjet printing. In another example, the crosslinker composition and the white ink composition may be maintained in separate containers, e.g., respective reservoirs/fluid supplies of respective inkjet cartridges, or separate compartments, e.g., respective reservoirs/fluid supplies, in a single container, e.g., inkjet cartridge.

### Textile Printing Methods

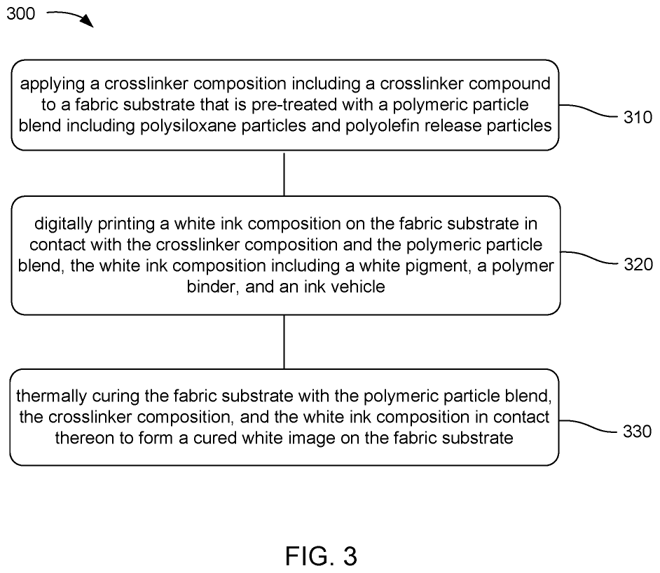

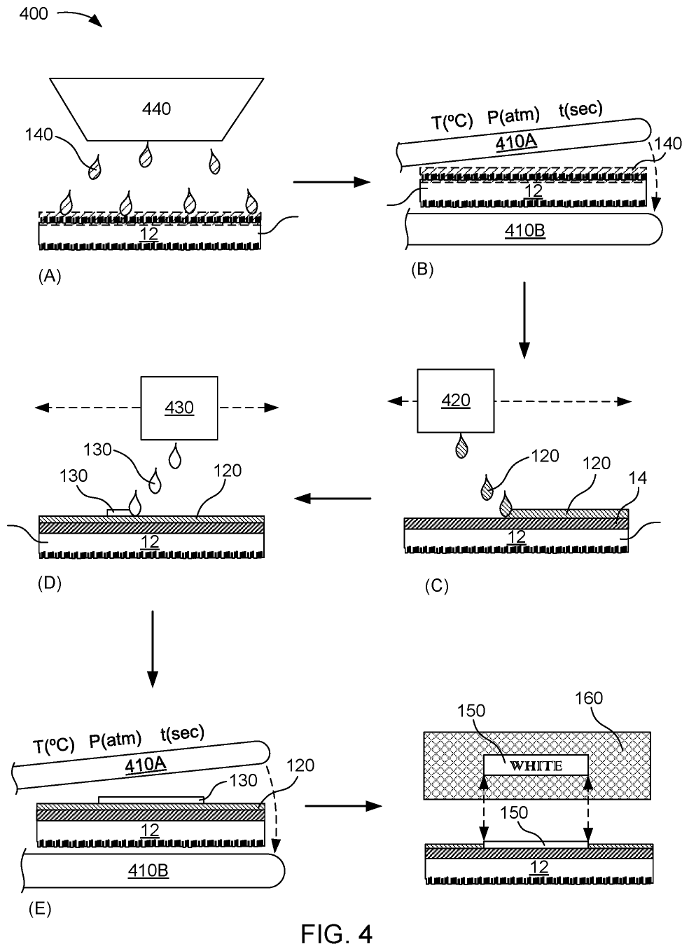

Example textile printing methods are illustrated at 300 in FIG. 3 and at 400 in FIG. 4. In FIG. 3 more specifically, a flow diagram of a method of textile printing can include applying 310 a crosslinker composition including a crosslinker compound to a fabric substrate that is pre-treated with a polymeric particle blend including polysiloxane particles and polyolefin release particles; digitally printing 320 a white ink composition on the fabric substrate in contact with the crosslinker composition and the polymeric particle blend; and thermally curing 330 the fabric substrate with the polymeric particle blend, the crosslinker composition, and the white ink composition in contact thereon to form a cured white image on the fabric substrate. The white ink in this example includes a white pigment, a polymer binder, and an ink vehicle. In some examples, the crosslinker composition and the white ink composition can be applied using multiple layers of either composition or multiple layers of both compositions, such as in a layer-by-layer manner, e.g., the crosslinker composition and the white ink composition applied in layers or even interleaved relative to one another in alternating succession. There may be, for example, from 2 to 10 individual layers of crosslinker composition applied and from 2 to 10 individual layers of white ink composition applied to the fabric substrate (pre-treated to include the polymeric particle blend therewith) in alternating application layers or some other pattern of layers that may not be alternating, but which provides for crosslinking to occur at the white ink composition, for example.

In one example, the method can include applying heat, pressure, or both to the pre-treatment layer on the fabric substrate prior to application of the crosslinker composition; applying heat, pressure, or both to the crosslinking layer prior to application of the white ink layer; or both. In further detail, the method can include washing the fabric substrate after forming the white image, wherein at a location where the white image is not formed on the crosslinker composition layer, polysiloxane particles is released from the fabric substrate while the polymer binder of the white ink is crosslinked to polysiloxane and remains on the fabric substrate. The method can utilize the pre-treated printable fabrics of FIG. 1 or the textile printing system as shown and described in FIG. 2, with the components thereof described in greater detail by way of example hereinafter.

With more specific reference to FIG. 4, a schematic diagram 400 illustrating application of various fluids to a fabric substrate in accordance with examples of the present disclosure. This is one example, and there may be various coating and/or printing steps carried out at other locations that than shown, or there may be application of the various fluids in printing and/or coating “zones.” The zones may include application zones, such as a pre-treatment composition application zone (A), a crosslinker composition application zone (C), and/or a white ink application zone (D). As shown in this example, the application of the crosslinker composition and the white ink composition can occur in immediate sequence, so these two application zones may be merged into a single zone (Zone C/D), but likewise may be at different zones. The application of the pre-treatment composition to form a polymeric particle blend on the fabric substrate as described herein can likewise be carried out in advance, with crosslinker composition and ink applied at the site of the printer. There may also be heating zones, where heat and in some instances pressure applied. In this example, there are two heating zones e.g., pre-treatment heating zone (B) and an ink curing zone (E). In another example, the heating zones can be the same zone (B/E). Zones are shown by way of convenience, as coating and printing can occur in a single zone with fluid applicators brought into position for application, such as on a carriage or by application with a bar applicator or can occur in fewer or more zones that shown.

In this specific example, as shown in FIG. 4, a fabric substrate 12 (or textile fabric) may be transported through pre-treatment application zone (A) where a pre-treatment composition 140 is applied to the fabric substrate to provide polymeric particle blend to the fabric substrate. As shown, the pre-treatment composition is applied to one side in this example and soaks partially into the fabric substrate, but could be applied to both sides, or could be applied throughout the fabric substrate, such as by a soaking or padding application process. For example, the applicator shown in FIG. 4 is a sprayer nozzle 440, which is an analog applicator, but could be a digital application such as a digital ejector, e.g., inkjet ejector such as a thermal or piezoelectric digital droplet ejector, or could be another analog-type of applicator or auto-analog applicator, e.g., roller, drawdown coater, slot die coater, fountain curtain coater, blade coater, rod coater, air knife coater, sprayer, gravure application, brush, padding applicator, etc. In an example, the pre-treatment composition can be applied in an amount up to about 10 gsm, based on the dry content, e.g., the dry polymeric particle blend and solids that may be present. In another example, the pre-treatment composition may be applied in an amount from 0.3 gsm to 10 gsm, from 1 gsm to 8 gsm, from 1 gsm to 5 gsm, from 3 gsm to 8 gsm, or from 2 gsm to 6 gsm, for example, based on dry content.

Next, the pre-treatment composition 140 disposed on the fabric substrate 12 may then be exposed to heat and pressure at a pre-treatment heating zone (B), where heat and pressure may be applied. In this example, the heat and pressure are shown being applied using a clam shell hot press 410A, 410B. Other heat applicators that can be used include a hot calendering roller, an iron, or another suitable heat and pressure applicator. The heat and/or pressure device can be used to enhance the printable surface of the fabric substrate by pressing down hair-like fibers of the fabric substrate that may otherwise stick-out in the z-axis direction relative to the flattened fabric surface. For example, rather than the clam shell hot press, the fabric substrate can be dipped or otherwise treated with a pre-treatment composition with the polymeric particle blend dispersed in a pre-treatment aqueous liquid vehicle, and then an excess volume of water other aqueous formulation components can then be squeegeed or rolled to push fibers down while removing the aqueous liquid vehicle therefrom. Incorporating a squeegee, rollers, hot press, heating oven, forced air heater, etc., can be used to flatten out the fabric fibers. However, it is noted that such a device may not be included for use in some examples.

In further detail regarding this example method, the application of heat and pressure may involve heating the fabric substrate (with the pre-treatment composition applied thereon) to a temperature (T) for a period of time (t) and at a pressure (P), leaving the polymeric particle blend 14 behind, shown in zone (C), with the liquid vehicle, e.g., water and/or other liquid components, being evaporated or substantially removed therefrom. The heat applied to pre-treatment layer on the fabric substrate ranges from 80° C. to 200° C. The pressure applied to the pre-treatment layer on the fabric substrate ranges from 1.5 psi to 120 psi, or 0.1 standard atmosphere (atm) to 8 atm. The heat and the pressure can be applied to pre-treatment layer on the fabric substrate for a period of time ranging from 10 seconds to 30 minutes. In one example, the temperature ranges from 100° C. to 150° C., the pressure ranges from 7 psi to 75 psi, and the time ranges for 1 minute to 30 minutes.

During the application of heat and pressure, if carried out, the polymeric particle blend 14 may remain with the fabric substrate 12. For example, the polymeric particle blend may coalesce to form a pre-treatment film either at a surface of the fabric substrate as shown in this FIG., or may be impregnated within the fabric substrate, as shown schematically in FIGS. 1 and 2 by way of example, such as by a padding application process or other application process. The application of heat and/or pressure may or may not be carried out at this stage, but in one example, application of heat and/or pressure can act to mat down a portion or even most/all of the hair-like fibers that may be present on the fabric substrate.

Next, the fabric substrate 12 can be transported through crosslinker composition application zone (C) and white ink composition application zone (D). In these two “printing zones, the crosslinker composition 120 is applied onto the fabric substrate (including the polymeric particle blend thereon) using a crosslinker composition ejector 420, such as a digital inkjet printhead or in some instances an analog applicator. The crosslinker composition can be applied, for example, at a basis weight ranging from 10 gsm to 100 gsm, from 25 gsm to 100 gsm, or from 50 gsm to 75 gsm, for example. Next, a white ink composition 130 is applied onto the crosslinker composition using an ink composition ejector 430, such as a digital inkjet printhead. In one example, the white ink composition can be applied in an amount ranging from 100 gsm to 400 gsm, from 150 gsm to 400 gsm, or from 200 gsm to 350 gsm, for example. It is noted that in some examples, the crosslinker composition and the white ink composition can both be applied repeatedly (simultaneous or in series or in various combinations of layers, etc.) to achieve a targeted weight basis of both compositions. These printing or application steps are shown in this FIG. as being applied using carriage printheads but may be fixed printheads where the media is moved near a print bar that is not on a carriage, for example. As a note the crosslinker composition layer may be dried (wet-on-dry) or not dried (wet-on-wet) prior to printing the white ink composition. Likewise, when applying the crosslinker composition or the white ink composition to the fabric substrate, the fabric substrate may be wet from application of the pre-treatment composition (wet-on-wet) or dried having the polymeric particle blend remaining thereon for application (wet-on-dry).

As shown at ink curing zone (E), the crosslinker composition 120 and the white ink composition 130 may be heated (with or without pressure). In this example, the heating zone may again be a clam shell hot press, as shown, but alternatively, may be configured to apply heat without pressure, e.g., heated air drying with air temperatures from 40° C. to 90° C. to remove water and other volatile solvents that may be present. In other examples, the curing temperature may be from 80° C. to 200° C. In still other examples, there may be an advantage to not disrupting the printed image with pressure; however, in other examples, there may be benefits to calendering the white image printed thereon. The resulting print may include a crosslinked white image 150, e.g., self-crosslinked and dried white ink composition, white ink composition dried and crosslinked to the fabric substrate, white ink composition dried and crosslinked to the polysiloxane polymer particles of the polymeric particle blend, any of which may be coalesced due to application of heat and/or pressure, for example. Areas not printed with white ink 160 may include the polymeric particle blend applied and/or the crosslinker composition, or neither.

In an example, the application of the pre-treatment composition, the crosslinker composition, and/or the white ink composition may be accomplished at a printing speed of 25 feet per minute (fpm) to 1200 fpm (or faster). In another example, the pre-treatment composition, the crosslinker composition, and/or the white ink composition may be applied at a printing speed ranging from 100 fpm to 1,000 fpm, for example. In another example the fabric substrate be pre-treated with the polymeric particle blend and the crosslinker composition and/or the white ink composition may be applied and/or printed at 25 fpm to 1200 fpm, or from 100 fpm to 1,000 fpm.

### Pre-Treatment Composition and Polymeric Particle Blend

Referring more specifically to the pre-treatment compositions, these compositions be used to apply the polymeric particle blend to or on the fabric substrate. Such arrangements or associations between the fabric substrate relative to the polymeric particle blends can be described herein as the fabric substrate being “pre-treated” or “pre-treated on” the polymeric particle blend (or pre-treatment composition that carries the polymeric particle blend to the fabric substrate). Such arrangements can include, without limitation, surface coatings, impregnation within fabric fibers, inter-fiber positioning between fiber of the fabric substrate, or any combination thereof.

The polysiloxane particles can provide a compound for chemical interaction, for example, thus reducing penetration of the crosslinker composition and/or white ink composition when applied to the fabric substrate. In one example, the hydrophobic nature of the polysiloxane particles can reduce white pigment penetration into the fabric substrate, leaving the white pigment at or near the surface to form a good white-colored film thereon. The polysiloxane particles can also provide favorable binding properties to hold down hair-like fibers that may otherwise protrude outward along a z-axis relative to the typically relatively flat x- and y-axes of the fabric substrate. Example polysiloxane particles that can be used may include, for example, an amino-functionalized polysiloxane, e.g., dimethyl amino silicon polymer, amino methyl-hydrogen silicone polymer, dimethyl/methyl siloxane and amino siloxane copolymer, etc., a polymethylhydrosiloxane (PMHS), a hydromethyl polysiloxane, a dimethyl polysiloxane, a hydromethyl-dimethyl polysiloxane, a polyhexamethyl disiloxane, a polydecamethyl tetrasiloxane, a polydodecamethyl pentasiloxane, a polyoctamethyl trisiloxane, a polyoctamethyl cyclotetrasiloxane, a polydodecamethyl cyclohexasiloxane, a polydecamethyl cyclopentasiloxane, or a combination thereof.

The polysiloxane particles, as can be seen from the above examples can be polymeric or non-polymeric, provided there are multiple siloxane groups present. The polysiloxane particles can be dispersed for delivery to a fabric substrate in a pre-treatment composition at from 0.5 wt % to 10 wt %, from 0.5 wt % to 5 wt %, or from 0.75 wt % to 3 wt %. The D50 particle size of the polysiloxane particles can be from 5 nm to 75 nm, from 5 nm to 50 nm, or from 10 nm to 25 nm, for example. The molecular weight (or the weight average molecular weight) of the polysiloxane particles can be from 500 Daltons to 70,000 Daltons, from 1,000 Daltons to 50,000 Daltons, or from 2,000 Daltons to 40,000 Daltons.

The polymeric particle blend pre-treated on the fabric substrate can also include polyolefin release particles. The presence of the polyolefin release particles can provide additional hydrophobicity to the fabric substrate, as well as particles that may not participate in crosslinking with the white ink composition and the crosslinker composition, when applied. Thus, the polyolefin release particles can help control white ink composition penetration into the fabric, can enhance film-forming properties, and can enhance white opacity provided by the white pigments staying closer to the surface of the fabric substrate. However, the polymeric particle blend may in some instances result in a stiff fabric substrate that may be undesirable for users, particularly when the fabric is being used as an article of clothing. For example, the use of an amino-functional silicone polymer can react with a carboxyl or a hydroxyl group on a fabric substrate, causing it to become stiffened and remain hydrophobic. The inclusion of the polyolefin release particles can provide for a solution where machine washing can cause the polymeric particle blend components to be released from the fabric, returning it to a softer state, while at the same time, retaining much of the print durability and opacity benefits provided by treatment of the fabric substrate with the polymeric particle blend. Without being bound by any particular theory, the polyolefin release particles, when applied and heat and/or pressure is applied, may form a barrier, or barrier spots, which may reduce chemical bonding between the polysiloxane particles and the fabric substrate. Example polyolefin release particle can include, for example, a polyethylene wax, a polypropylene wax, a copolymer of ethylene and propylene, a copolymer of ethylene and propylene with C4 to C8 alpha-olefin sidechains, or a combination thereof.

In a few specific examples, the polyolefin release particles can be applied from a pre-treatment composition with a polyethylene-based dispersion, a polypropylene-based dispersion, or a dispersion of copolymer of ethylene and propylene with alpha-olefins as butene, hexene, or octene, with the alpha-olefins present as the short side-chain pendent groups on the polyethylene or polypropylene backbones.

The polyolefin release particles can be dispersed for delivery to a fabric substrate in a pre-treatment composition at from 0.5 wt % to 10 wt %, from 1 wt % to 6 wt %, or from 1.5 wt % to 5 wt %. The D50 particle size of the polyolefin particles can be from 0.1 μm to 50 μm, from 5 μm to 50 μm, or from 10 μm to 25 μm, for example. The molecular weight (or the weight average molecular weight) of the polyolefin particles can be from 50,000 Daltons to 300,000 Daltons, from 75,000 Daltons to 250,000 Daltons, or from 100,000 Daltons to 200,000 Daltons.

The polymeric particle blend in some examples, can be co-formulated with another component, which may or may not be a polymer. For example, a fixer compound can be applied to the fabric substrate with the pre-treatment composition along with the polymeric particle blend. The fixer composition may include a fixer compound, such as an inorganic metal salt, an organic acid salt, an ionene salt, or a combination thereof.

Inorganic metal salts that can be used in include salts of cationic Group I metals, Group II metals, Group III metals, and/or a transition metals. Specific examples of these metals can include sodium, calcium, copper, nickel, magnesium, zinc, barium, iron, aluminum, chromium, and/or the like. The associated complex anion can be a halide ion, such as chloride, iodide, bromide, fluoride, etc., or can be a nitrate, sulfate, sulfite, phosphate, chlorate, and/or acetate, etc. In some examples, the inorganic metal salt can be a multivalent metal salt.

Organic acid salts can be included as well as the fixing compound and can be water-soluble or water-dispersible. Examples may include aliphatic organic acid salts and/or organic acid salts with complex organic ions, where cations may or may not the same as inorganic salt, e.g., metal cations. Example organic acid salts may include an anionic compounds having the formula CₙH₂ₙ₊₁COO⁻M⁺*H₂Oₘ, where M is cation species selected from Group I metals, Group II metals, Group III metals, transition metals, such as sodium, potassium, calcium, copper, nickel, zinc, magnesium, barium, iron, aluminum, chromium, etc. The anionic group can include any negatively charged carbon species with a value of n ranging from 1 to 35. The hydrates (H₂O) may be present and attached to the salt, with an m value from 0 to 20. Example organic acid salts include metal acetates, metal propionates, metal formates, metal oxalates, and/or the like. Examples of water-dispersible organic acid salts include a metal citrates, metal oleates, metal oxalates, and the like.

The fixer compound can also be a cationic polymer, such as an ionene compound. The term “ionene” refers to a polymeric compound having ionic groups as part of the main chain, where ionic groups can exist on the polymer backbone, or can be present on a side-chain group appended from the polymer backbone. In other words, the ionic group of an ionene compound repeats either along the backbone or repeats to some degree along a side-chain.

Example ionone compounds in the form of charged cationic polymers include poly-diallyl-dimethyl-ammonium chloride, poly-diallyl-amine, polyethylene imine, poly2-vinylpyridine, poly 4-vinylpyridine poly2-(tert-butylamino)ethyl methacrylate, poly 2-am inoethyl methacrylate hydrochloride, poly 4′-diamino-3,3′-dinitrodiphenyl ether, poly N-(3-aminopropyl)methacrylamide hydrochloride, poly 4,3,3′-diam inodiphenyl sulfone, poly 2-(iso-propylamino)ethylstyrene, poly2-(N,N-diethylamino)ethyl methacrylate, poly 2-(diethylamino)ethylstyrene, 2-(N,N-dimethylamino)ethyl acrylate, or a combination thereof.

Example naturally occurring ionene compounds may include cationic gelatin, cationic dextran, cationic chitosan, cationic cellulose, cationic cyclodextrin, or a combination thereof. Example synthetically-modified naturally occurring ionene compounds include modified chitosan, e.g., carboxymethyl chitosan, N,N,N-trimethyl chitosan chloride, etc.

Example ionene compounds with ionic groups along the polymer backbone include alkoxylated quaternary polyamine. In some examples, the nitrogen can be quaternized. In some other examples, the ionene compound can include a charged species along a side-chain appended to the backbone as part of a repeating unit. An example may include a quaternized poly(4-vinyl pyridine) with a quaternized amine on an aromatic ring. These and other ionene compounds can have a weight average molecular from 100 Mw to 8,000 Mw, from 250 Mw to 6,000 Mw, or from 500 Mw to 5,000 Mw. Weight average molecular weight of polymers can be measured herein by gel permeation chromatography with the polystyrene standard, for example.

In still other examples, if present, the ionene compound may include alkoxylated quaternary polyamine, polyamine, polyacrylate diamine, quaternary ammonium, polyoxyethylenated amine, quaternized polyoxyethylenated amine, poly-dicyandiamide, poly-diallyl-dimethyl ammonium, quaternized dimethylaminoethyl(meth)acrylate polymer, polyethyleneimine, branched polyethyleneimins, quaternized poly-ethylenimine, polyuria, poly[bis(2-chloroethyl)ether-alt-1,3bis[3-(dimethylamino)propyl]urea], quaternized poly[bis(2-chloroethyl)ether-alt-1,3-bis[3-(dimethylamino)propyl], quaternized vinyl-imidazol polymer, modified cationic vinyl alcohol polymer, alkyl-guanidine polymer, salts thereof, vinyl copolymers thereof, and/or the like. In other examples, the ionene compound can include polyimines and/or their salts, such as linear polyethyleneimines, branched polyethyleneimines and/or quaternized polyethyleneimine. In some other examples, the ionene compound can include substitute of urea polymer or salt thereof, such as poly[bis(2-chloroethyl)ether-alt-1,3 bis[3-(dimethylamino)propyl]urea], and/or quaternized poly[bis(2 chloro-ethyl)ether-alt-I,3 -bis [3-(dimethylamino)propyl]. In some other examples, the ionene compound can be a vinyl polymer and/or a salt thereof such as quaternized vinyl-imidazol polymer, modified cationic vinyl-alcohol polymer, alkyl-guanidine polymer, and/or a combination thereof. The ionene compound can be a homopolymer of diallyl-dimethyl-ammonium chloride (poly-DADMA), in one example.

Commercially available ionene polymers can be found, for examples, under the tradename BTMS-50, INCROQUAT® CR or INDUQUAT® ECR, available from Indulor Chemie GmbH (Germany); FLOQUAT® series polymers, available from SFN Inc.; QUAB® series polymers, available from SKW Quab Chemicals Inc.; TRAMFLOC® series polymers, available from Tramfloc Inc.; ZETAG® series polymers, available from BASF, and ZHENGLI®, available from Zleor Chemicals Ltd.

As mentioned, the polymeric particle blend can be applied to the fabric substrate, for example, from a pre-treatment composition that includes a co-dispersion of the polymeric particle blend, e.g., dispersed polysiloxane particles and dispersed polyolefin release particles, using any of a number of analog application processes, e.g., knife coating or direct coating, direct roll coating, pad-dry-cure coating, calendar coating- hot melt extrusion coating, foam finishing coating, or the like. In one specific example, a pad-dry-cure process (or padding process) can be used where the fabric is soaked and the excess coating composition can be rolled out. More specifically, impregnated fabric substrates (prepared by bath, spraying, dipping, etc.) can be passed through padding nip rolls under pressure. The resulting polymeric particle blend can then be said to be applied to or on the fabric substrate, for example, forming an impregnated fabric, which after nip rolling, can then be air dried or more typically dried by heat, forced air, heat and forced air, etc. Drying can be controlled, for example, by a machine speed with a peak fabric web temperature that is suitable for the fabric being coated, e.g., the temperature does not damage the underlying fabric substrate. In some examples, pressure can be applied to the fabric substrate after application of the pre-treatment composition, such as by pressure padding. During this type of operation, the fabric base substrate may be dipped into a pan containing the pre-treatment composition and then the soaked fabric is then passed through the gap of padding rolls to control the amount of polymeric particle blend that is applied. In some examples, the pressure that is applied can be from 10 psi to 150 psi, for example, or from 30 psi to 70 psi. In other examples, drying can be by use of a box hot air dryer. The dryer can be a single unit or could be in a serial of 2 to 10, or 3 to 7 units, so that a temperature profile can be created with initial higher temperature (to remove excessive water) followed by milder temperature(s), e.g., drying to from 1 wt % to 5 wt % moisture content. The peak dryer temperature can be programmed into a profile with higher temperature at begging of the drying when wet moisture is high and reduced to lower temperature when web becoming dry. The dryer temperature is controlled to a temperature of less than about 100° C. In some examples, the operation speed of the padding/drying line is 50 yards per minute.

Application of the pre-treatment coating to leave a polymeric particle blend on the fabric can occur at a location separate from printing, or can occur at the site of the printer, e.g., using the printer or a device in-line processing device relative to the printer, for example. In this example, the pre-treatment composition can be applied on the fabric substrate and then passed to the print head for wet-on-wet printing or can be first dried for wet-on-dry printing applications. For example, the fabric substrate can be passed under an adjustable spray nozzle that may be programmed or established to alter the rate or other parameters at which the pre-treatment solution is sprayed onto the fabric substrate. Other variables that can be adjusted or predetermined may include the rate or volume at which the solution is spayed on the fabric substrate, the distance the substrate is from the sprayer nozzle, the spraying profile of the nozzle, the concentration of the pre-treatment solution, the type of pre-treatment composition attributes to be deposited on the fabric substrate, etc.

As mentioned, the polymeric particle blend can be applied using a pre-treatment composition. The pre-treatment composition may have a viscosity ranging from 1 centipoise (cP) to 100 cP at a temperature of about 25° C. (measured at a shear rate of 3,000 Hz, e.g., with a Hydramotion Viscolite viscometer). Other viscosity ranges may be from 1 cP to 80 cP, from 3 cP to 60 cP, from 5 cP to 50 cP, from 20 cP to 100 cP, from 30 cP to 100 cP, from 1 cP to 30 cP, or from 2 cP to 20 cP, for example. Depending upon the viscosity, the pre-treatment composition may be applied on the fabric substrate using an analog method or a digital method. It is to be understood that the viscosity of the pre-treatment composition may be adjusted for the type of analog coater that is to be used. On the other hand, when the pre-treatment composition 12 is to be applied with a thermal inkjet printer or in a piezoelectric inkjet printer, the viscosity of the pre-treatment composition may be adjusted for the type of printhead that is to be used, e.g., by adjusting the co-solvent level. When used in a thermal inkjet printer, the viscosity of the pre-treatment composition may be modified to range from 1 cP to 15 cP (at 25° C. and a shear rate of 3,000 Hz), and when used in a piezoelectric printer, the viscosity of the pre-treatment composition may be modified to range from 1 cP to 30 cP (at 20° C. to 25° C. and a shear rate of 3,000 Hz). The viscosity of the pre-treatment composition to be digitally printed may also be adjusted based on the type of the printhead that is being used, e.g., low viscosity printheads, medium viscosity printheads, or high viscosity printheads. The pH of the pre-treatment composition that includes the polymeric particle blend of the polysiloxane particles and the polyolefin release particles may be range, for example, from pH 3 to pH 7, from pH 4 to pH 6.5, or from pH 3 to pH 6. pH can be measured using a pH meter from Fisher Scientific (ACCUMET XL250).

### Crosslinker Composition

A crosslinker composition can include a crosslinker compound, which can be, for example, a compound with multiple crosslinking groups capable of bonding at multiple locations for purposes of linking one or more compounds together, or which includes a cationic heterocyclic ring structure that when opened, can crosslink one or multiple components together. The crosslinker composition can include the crosslinker compound carried by a crosslinker liquid vehicle, for example. In some examples, the crosslinker compound can be a non-polymeric crosslinker compound, and in other examples, the crosslinking compound can be a polymeric crosslinking compound. The non-polymeric crosslinker compound, for example, can have a molecular weight of 300 Daltons to 3,000 Daltons. On the other hand, a polymeric crosslinker compound may have a weight average molecular weight can be from 3,000 Mw to 3,000,000 Mw, for example. Any weight average molecular weight (Mw) throughout this disclosure may be expressed as Mw and is also in Daltons. In some examples, e.g., when the crosslinker composition includes the polymeric crosslinker compound and the crosslinker composition is to be thermally printed, the cationic polymer included in the crosslinker composition can have a weight average molecular weight from 3,000 Mw to 200,000, or from 3,000 Mw to 100,000 Mw, or from 3,000 Mw to 50,000 Mw, for example. This molecular weight may provide for the polymeric crosslinker compound to be printed by thermal inkjet printheads with good print reliability in many instances. When using other application technologies to eject the polymeric crosslinker composition, higher molecular weights may be useable, such as from 200,000 Mw to 3,000,000 Mw, e.g., applied by piezoelectric printheads and/or analog methods. When the crosslinker composition contains a non-polymeric crosslinker compound, the molecular weight range described above can typically be suitable for both thermal inkjet printing as well as other application technologies.

Examples of the cationic polymers that can be used as polymeric crosslinking compounds include poly(diallyldimethylammonium chloride); or poly(methylene-co-guanidine) anion with the anion is selected from the hydrochloride, bromide, nitrate, sulfate, or sulfonate; a polyamine; poly(dimethylamine-co-epichlorohydrin); a polyethylenimine; a polyamide epichlorohydrin resin; a polyamine epichlorohydrin resin; or a combination thereof. In some examples, the polymeric crosslinking compound include a heterocyclic cationic ring structure, such as commercially available polyamine epichlorohydrin resins, which may also be referred to azetidinium-containing polyamines, or other heterocyclic cationic ring-containing polymers. Examples of such cationic ring-containing polymer that may be used include BEETLE™ PT746, available from BIP (Oldbury) Ltd.; as well as CREPETROL™ 73, KYMENE™ 736, KYMENE™ 736NA, POLYCUP™ 8210, POLYCUP™ 9200, POLYCUP™ 7535, POLYCUP™ 2000, POLYCUP™ 172, POLYCUP™ 9700, POLYCUP™ 1884, POLYCUP™ 7360, and POLYCUP™ 7360A, which are available from Solenis LLC.

In further detail, in examples that include a four-membered heterocyclic ring-containing group as part of the crosslinker compound, including both non-polymeric crosslinker compounds and polymeric crosslinkers, in an uncrosslinked state, such a group can be represented as in accordance with Formula I, as follows:

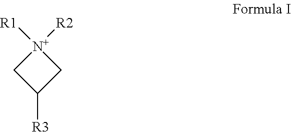

where R3 is hydrogen, hydroxyl, carboxyl, acetoxy, alkoxy, amino, or alkyl; R1 and R2 are independently hydrogen, C1-C6 alkyl, and/or alkoxy, for example, or can represent the balance of a polymer chain including additional heterocyclic groups as shown in Formula I, other amine groups, alkyl linking groups, etc. The counterion to the quaternary amine of Formula I can be a halide ion, such as a chloride, fluoride, bromide, iodide, or the like. In more specific examples where R3 is a hydroxyl group, the structure may be referred to as an azetidinium salt, e.g., azetidinium crosslinker compound. In these or other examples, the quaternary amine nitrogen has a positive charge, and thus can be reactive with chemical groups such as carboxylates, amines, phenols, thiols, phosphorus nucleophiles, etc. Example ring-opening reactions are provided in Equations 1-4, as follows:

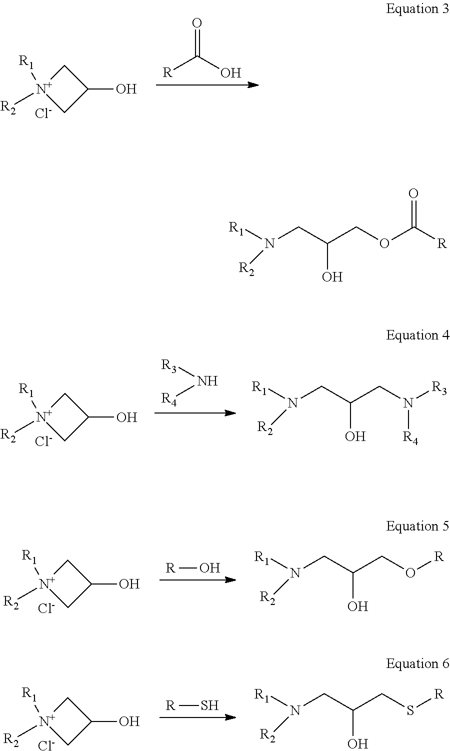

In some specific examples, the crosslinker compound can include a salt of a diallylazetidium, a bis(2-methoxyethyl)azetidinium, a nonylpropylazetidinium, an undecylmethylazetidinium, a nonylpropargylazetidinium, as illustrated by example below.

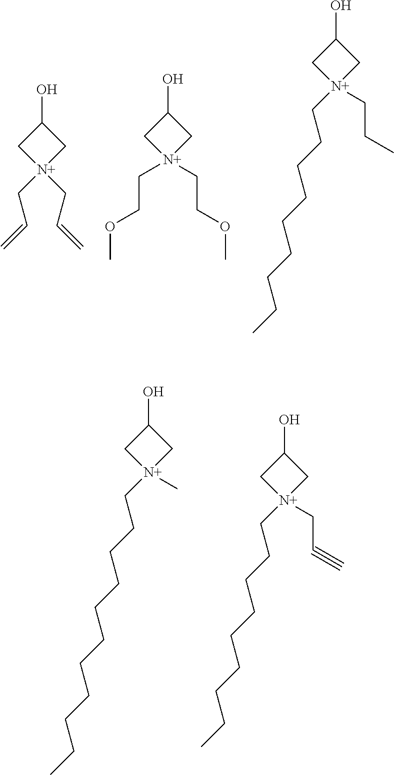 [SMILES: C=CC[N+]1(CC=C)CC(O)C1 ; COCC[N+]1(CCOC)CC(O)C1 ; CCCCCCCCC[N+]1(CCC)CC(O)C1 ; CCCCCCCCCCC[N+]1(C)CC(O)C1 ; C#CC[N+]1(CCCCCCCCC)CC(O)C1]

Other example azetidinium salts that can be prepared can include a variety of compounds prepared by reacting various JEFFAMINE® polymers, available from Huntsman Chemical (USA), with epichlorohydrin, as shown bel

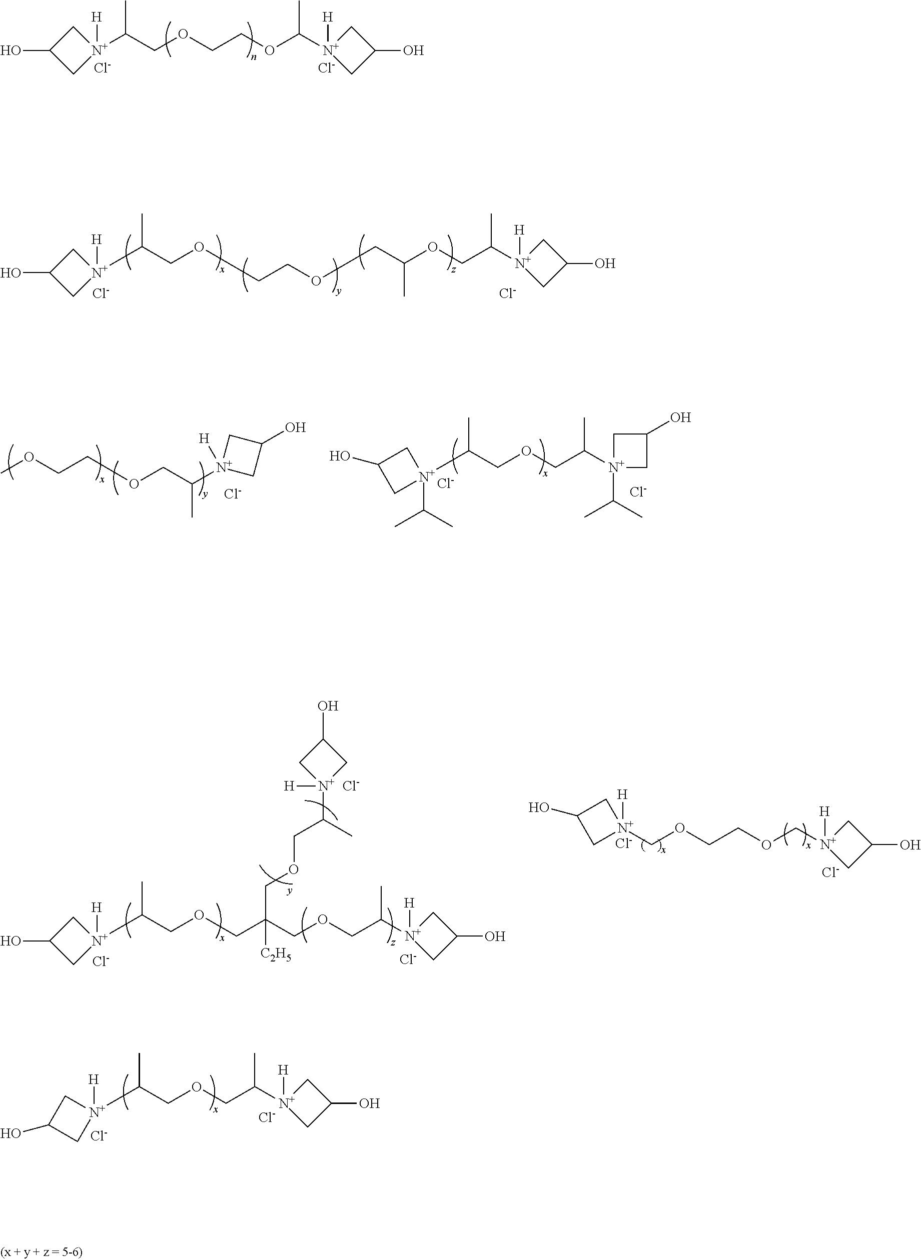

where x, y, and z can independently be from 1 to 5

In other examples, the crosslinker compound can be a polyamidoamine, a polyethylene imine, a polyamidoaminester, or polyester backbone with pendant secondary amine groups, etc.

The crosslinking compound can be present in the crosslinking composition in amount ranging from 0.5 wt % to 15 wt %, from 1 wt % to 15 wt %, from 1 wt % to 10 wt %, from 4 wt % to 8 wt %, from 2 wt % to 7 wt %, or from 6 wt % to 10 wt %, based on a total weight of the crosslinker composition. The crosslinker composition can further include a crosslinker liquid vehicle to carry the crosslinker compound, for example. As used herein, the term “crosslinker liquid vehicle” may refer to the liquid in which the crosslinker is mixed to form the crosslinker composition. The crosslinker liquid vehicle can be an aqueous vehicle including water, and may include other liquid components, such as organic co-solvent, surfactant, chelating agent, a pH adjuster, etc.

If a surfactant is included, the surfactant in the crosslinker composition may be an anionic, non-ionic, or cationic surfactant in any amount set forth herein based on a total weight of the crosslinker composition. The surfactant may be present in an amount ranging from 0.01 wt % to 5 wt % (based on the total weight of the crosslinker composition). In an example, the surfactant is present in the crosslinker composition in an amount ranging from 0.05 wt % to 3 wt %, based on the total weight of the crosslinker composition. In another example, the surfactant is present in the white ink composition in an amount of 0.3 wt %, based on the total weight of the crosslinker composition.

The co-solvent in the crosslinker composition may be any example of the co-solvents set forth herein for the pre-treatment composition 12 previously, in any amount set forth herein for the pre-treatment composition (except that the amount(s) are based on the total weight of the crosslinker composition instead of the pre-treatment composition).

Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsul fonate, and dibutylphenylphenol disulfonate. Examples of the cationic surfactant include quaternary ammonium salts, such as benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, alkylbenzyldimethylammonium chlorides, distearyldimethylammonium chloride, diethyl ester dimethyl ammonium chloride, dipalmitoylethyl hydroxyethylmonium methosulfate, and ACCOSOFT® 808 (methyl (1) tallow amidoethyl (2) tallow imidazolinium methyl sulfate available from Stepan Company). Other examples of the cationic surfactant include amine oxides, such as lauryldimethylamine oxide, myristamine oxide, cocamine oxide, stearamine oxide, and cetamine oxide. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

A chelating agent may be present in the crosslinker composition in an amount from 0.01 wt % to 0.5 wt % based on the total weight of the crosslinker composition. In an example, the chelating agent is present in an amount ranging from 0.05 wt % to 0.2 wt % based on the total weight of the crosslinker composition. The chelating agent may be selected from methylglycinediacetic acid, trisodium salt; 4,5-dihydroxy-1,3-benzenedisulfonic acid disodium salt monohydrate, ethylenediaminetetraacetic acid (EDTA), hexamethylenediamine tetra(methylene phosphonic acid), potassium salt, or a combination thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

A pH adjuster may also be included in the crosslinker composition, such as to achieve a target pH level, e.g., from 1 to 7 pH, from 2 to 6 or from 3 to 4, and/or to counteract any slight pH increase that may occur over time or during formulation. In an example, the total amount of pH adjuster(s) in the crosslinker composition, if used, can be from 0.01 wt % to 0.5 wt %, based on the total weight of the crosslinker composition. In another example, the total amount of pH adjuster(s) in the crosslinker composition can be from 0.02 wt % to 0.1 wt %, based on the total weight of the crosslinker composition. An example of a pH adjuster that may be used in the crosslinker composition includes methane sulfonic acid.

The viscosity of the crosslinker composition may vary depending upon the application method that is to be used to apply the crosslinker composition. As an example, when the crosslinker composition is to be applied with an analog applicator, the viscosity of the crosslinker composition may range from 1 centipoise (cP) to 300 cP (at 25° C. and a shear rate of 3,000 Hz), from 10 cP to 300 cP, or from 20 cP to 300 cP. As other examples, when the crosslinker composition is to be applied with an thermal inkjet applicator/printhead, the viscosity of the crosslinker composition may range from 1 cP to 15 cP (at 25° C. and a shear rate of 3,000 Hz), and when the crosslinker composition is to be applied with an piezoelectric inkjet applicator/printhead, the viscosity of the crosslinker composition may range from 1 cP to 30 cP (at 25° C. and a shear rate of 3,000 Hz).

### White Ink Composition

A white ink composition 16 includes a white pigment, a polymer binder, and an ink vehicle. In some examples, the white ink composition consists of the white pigment, the polymer binder, and the ink vehicle. In other examples, the white ink composition may include additional components.

Examples of suitable white pigments include white metal oxide pigments, such as titanium dioxide (TiO₂), zinc oxide (ZnO), zirconium dioxide (ZrO₂), or the like. In one example, the white pigment includes or is titanium dioxide. In an example, the titanium dioxide may be in its rutile form. In some examples, the white pigment may include white metal oxide pigment particles coated with silicon dioxide (SiO₂). In one example, the white metal oxide pigment content to silicon dioxide content can be from 100:3.5 to 5:1 by weight. In other examples, the white pigment may include white metal oxide pigment particles coated with silicon dioxide (SiO₂) and aluminum oxide (Al₂O₃). In one example, the white metal oxide pigment content to total silicon dioxide and aluminum oxide content can be from 50:3 to 4:1 by weight. In other examples, the white pigment may be co-dispersed with pigments that are not white per se, but may enhance the opacity of the white pigment by preventing the white pigment from becoming packed tightly, e.g., silica particles, alumina particles, etc. One example of the white pigment includes TI-PURE® R960 (TiO₂ pigment powder with 5.5 wt % silica and 3.3 wt % alumina (based on pigment content)) available from Chemours. Another example of the white pigment includes TI-PURE® R931 (TiO₂ pigment powder with 10.2 wt % silica and 6.4 wt % alumina (based on pigment content)) available from Chemours. Still another example of the white pigment includes TI-PURE® R706 (TiO₂ pigment powder with 3.0 wt % silica and 2.5 wt % alumina (based on pigment content)) available from Chemours.

The white pigment may have high light scattering capabilities, and the average particle size of the white pigment may be selected to enhance light scattering and lower transmittance, thus increasing opacity. The average particle size of the white pigment may range anywhere from 100 nm to 2,000 nm. In some examples, the average particle size ranges from 120 nm to 2,000 nm, from 150 nm to 1,000 nm, from 150 nm to 750 nm, or from 200 nm to 500 nm. The term “average particle size”, as used herein, may refer to a volume-weighted mean diameter of a particle distribution.

In an example, the white pigment is present in an amount ranging from 1 wt % to 20 wt %, based on a total weight of the white ink composition 16. In other examples, the white pigment is present in an amount ranging from 3 wt % to 20 wt %, from 5 wt % to 20 wt %, from 5 wt % to 15 wt %, or from 1 wt % to 10 wt %, based on a total weight of the white ink composition 16. In still another example, the white pigment is present in an amount of 10 wt % or 9.75 wt %, based on a total weight of the white ink composition.

The white pigment may be dispersed with the pigment dispersant, such as a water-soluble acrylic acid polymer, a branched co-polymer of a comb-type structure with polyether pendant chains and acidic anchor groups attached to a backbone, or a combination thereof. Other dispersants may also be used. Some examples of the water-soluble acrylic acid polymers that can be used as dispersants include CARBOSPERSE® K7028 (polyacrylic acid having a weight average molecular weight (Mw) of 2,300), CARBOSPERSE® K752 (polyacrylic acid having a weight average molecular weight (Mw) of 2,000 Daltons), CARBOSPERSE® K7058 (polyacrylic acid having a weight average molecular weight (Mw) of 7,300), and CARBOSPERSE® K732 (polyacrylic acid having a weight average molecular weight (Mw) of 6,), all available from Lubrizol Corporation. Some examples of the branched co-polymer of the comb-type structure with polyether pendant chains and acidic anchor groups attached to the backbone include DISPERBYK®-190 (an acid number of 10 mg KOH/g) and DISPERBYK®-199, both available from BYK Additives and Instruments, as well as DISPERSOGEN® PCE available from Clariant. In some examples, the pigment dispersant includes both the water-soluble acrylic acid polymer and the branched co-polymer of the comb-type structure with polyether pendant chains and acidic anchor groups attached to the backbone. In some of these examples, the pigment dispersant includes CARBOSPERSE® K7028 and DISPERBYK®-190. In some of these examples, the pigment dispersant includes both the water-soluble acrylic acid polymer and the branched co-polymer of the comb-type structure with polyether pendant chains and acidic anchor groups attached to the backbone, where the water-soluble acrylic acid polymer is present in an amount ranging from 0.02 wt % to 0.4 wt %, and the branched co-polymer of the comb-type structure with polyether pendant chains and acidic anchor groups attached to the backbone is present in an amount ranging from 0.03 wt % to 0.6 wt %. In one of these examples, the water-soluble acrylic acid polymer is present in an amount of 0.09 wt %, and the branched co-polymer of the comb-type structure with polyether pendant chains and acidic anchor groups attached to the backbone is present in an amount of 0.14 wt %.

In some examples, the pigment dispersant(s) may be present in an amount ranging from 0.05 wt % to 1 wt %, based on a total weight of the white ink composition 16. In one of these examples, the dispersant is present in an amount of 0.1 wt % to 0.75 wt %, based on a total weight of the white ink composition.

The white ink composition 16 may also include a polymer binder. The polymer binder in the white ink composition may be any example of the anionic polymer binders or the non-ionic polymer binder set forth herein for the pre-treatment composition 12, in any amount set forth herein for the pre-treatment composition (except that the amount(s) are based on the total weight of the white ink composition instead of the pre-treatment composition). The polymer binder (prior to being incorporated into the white ink composition) may be dispersed in water alone or in combination with an additional water soluble or water miscible co-solvent, such as those described for the pigment dispersion. It is to be understood however, that the liquid components of the binder dispersion become part of the ink vehicle in the white ink composition.

The white pigment may be incorporated into the white ink composition 16 as a white pigment dispersion. The white pigment dispersion may include a white pigment and a separate pigment dispersant, for example. For the white pigment dispersions disclosed herein, it is to be understood that the white pigment and separate pigment dispersant (prior to being incorporated into the ink formulation), may be dispersed in water alone or in combination with additional water-soluble or water miscible co-solvent(s). Likewise, the dispersion can be formulated into a white ink composition by adding additional components to the dispersion, similar to that in the dispersion, or by adding additional components. Example organic co-solvents that can be included in the white pigment dispersion or further added to formulation the white in composition include co-solvents such as 2-pyrrolidone, 1-(2-hydroxyethyl)-2-pyrrolidone, glycerol, 2-methyl-1,3-propanediol, 2,2-dimethyl-1,3-propanediol, 1,2-butane diol, diethylene glycol, 1,3-propanediol, 1,4-butanediol, 1,5-pentanediol, triethylene glycol, tetraethylene glycol, hexylene glycol, or a combination thereof. It is to be understood however, that the liquid components of the white pigment dispersion become part of the ink vehicle in the white ink composition, or the solvents can be added to dispersions in formulating the white ink compositions. Other co-solvents mentioned herein, such as in the context of the pre-treatment coating composition, as well as others, can likewise be used.

Thus, in addition to the white pigment and any other solids that may be present, e.g., polymer binder, the white ink composition includes an ink vehicle. As used herein, the term “ink vehicle” may refer to the liquid with which the white pigment (dispersion) and any other solids are dispersed to form a white ink composition. A wide variety of vehicles may be used with the white ink composition(s) of the present disclosure. The ink vehicle may include water and any of a co-solvent, an anti-kogation agent, an anti-decel agent, a surfactant, an antimicrobial agent, a pH adjuster, or combinations thereof. In an example of the ink white ink composition, the vehicle includes water and a co-solvent. In another example, the vehicle consists of water and the co-solvent, the anti-kogation agent, the anti-decel agent, the surfactant, the antimicrobial agent, a pH adjuster, e.g., to achieve a pH from 5 to 9, or a combination thereof. In still another example, the ink vehicle consists of the anti-kogation agent, the anti-decel agent, the surfactant, the antimicrobial agent, a pH adjuster, and water.

Examples of the white ink composition 16 disclosed herein may be used in a thermal inkjet printer or in a piezoelectric printer. The viscosity of the white ink composition may be adjusted for the type of printhead by adjusting the co-solvent level, adjusting the polymer binder level, and/or adding a viscosity modifier. When used in a thermal inkjet printer, the viscosity of the white ink composition may be modified to range from 1 cP to 15 cP (at 25° C. measured at a shear rate of 3,000 Hz). When used in a piezoelectric printer, the viscosity of the white ink composition may be modified to range from 1 cP to 30 cP (at 25° C. measured at a shear rate of 3,000 Hz), depending on the type of the printhead that is being used, e.g., low viscosity printheads, medium viscosity printheads, or high viscosity printheads.

### Fabric Substrates

In the examples disclosed herein, the “fabric substrate,” as shown in FIGS. 1, 2 and 4, may be constructed from a fabric material polyester, polyester blend, cotton, cotton blend, nylon, nylon blend, silk fabrics, silk blend fabrics, wool fabrics, wool blend fabrics, or a combination thereof. In a further example, the fabric substrate is selected from the cotton fabrics or cotton blend fabrics. It is to be understood that organic fabric substrates and/or inorganic fabric substrates may be used for the fabric substrate. Some types of fabrics that can be used include various fabrics of natural and/or synthetic fibers. It is to be understood that the polyester fabrics may be a polyester coated surface. The polyester blend fabrics may be blends of polyester and other materials, e.g., cotton, linen, etc. In another example, the fabric substrate may be selected from nylons (polyam ides) or other synthetic fabrics.

Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources, e.g., cornstarch, tapioca products, sugarcanes, etc. Example synthetic fibers used in the fabric substrate can include polymeric fibers such as nylon fibers, polyvinyl chloride (PVC) fibers, PVC-free fibers made of polyester, polyamide, polyimide, polyacrylic, polypropylene, polyethylene, polyurethane, polystyrene, polyaramid, e.g., Kevlar®, polytetrafluoroethylene (Teflon®) (both trademarks of E.I. du Pont de Nemours and Company, Delaware), fiberglass, polytrimethylene, polycarbonate, polyethylene terephthalate, polyester terephthalate, polybutylene terephthalate, or a combination thereof. In an example, natural and synthetic fibers may be combined at ratios of 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

In addition, the fabric substrate can contain additives, such as a colorant, e.g., pigments, dyes, and tints, an antistatic agent, a brightening agent, a nucleating agent, an antioxidant, a UV stabilizer, a filler, and/or a lubricant, for example.

The terms “textile fabric” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles, e.g., clothing, blankets, tablecloths, napkins, towels, bedding material, curtains, carpet, handbags, shoes, banners, signs, flags, etc. In some examples, the fabric substrate can have a woven, knitted, non-woven, or tufted fabric structure. In one example, the fabric substrate can be a woven fabric where warp yarns and weft yarns can be mutually positioned at an angle of 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process, e.g., a solvent treatment, a mechanical treatment process, e.g., embossing, a thermal treatment process, or a combination of multiple processes.

In one example, the fabric substrate can have a basis weight ranging from 10 gsm to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

The fabric substrate may be any color, and in example, is a color other than white. In further detail, the color can be a dark color, such as a color having an L* value from 0 to 50, or from 10 to 35, from 5 to 25, or from 10 to 20, for example.

### Definitions

It is noted that, as used in this specification and the appended claims, the singular forms “a,” “an,” and “the” include plural referents unless the content clearly dictates otherwise.

As used herein, weight percentage that is often referred to as “wt %,” which typically refers to the loading of the specifically listed component, or active ingredient, unless noted otherwise, even if that component was supplied with other ingredients. For example, a white pigment may be present in a water-based pigment dispersion formulation, e.g., a stock solution or dispersion, before being incorporated into the white ink composition. In this example, the wt % of the white pigment accounts for the loading (as a weight percent) of the white pigment(s) per se that is present in the white ink composition, and does not account for the weight of the other components, e.g., water, etc., that are present in the formulation with the white pigment. If a percentage is given without identifying the type of percentage, it understood to be weight percent unless the context is clearly otherwise.

Reference throughout the specification to “one example”, “another example”, “an example”, and so forth, means that a particular element, e.g., feature, structure, and/or characteristic, described in connection with the example is included in at least one example described herein, and may or may not be present in other examples. In addition, it is to be understood that the described elements for any example may be combined in any suitable manner in the various examples unless the context clearly dictates otherwise.

“D50” particle size is defined as the particle size at which about half of the particles are larger than the D50 particle size and about half of the other particles are smaller than the D50 particle size (by weight based on the metal particle content of the particulate build material). As used herein, particle size with respect to the polyurethane binder particles can be based on volume of the particle size normalized to a spherical shape for diameter measurement, for example. Particle size can be collected using a Malvern ZETASIZER™ from Malvern Panalytical (United Kingdom), for example. Particle size information can also be determined and/or verified using a scanning electron microscope (SEM) or can be measured using a particle analyzer such as the MASTERSIZER™ 3000 available from Malvern Panalytical, for example. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those in the field technology determine based on experience and the associated description herein.

As used herein, a plurality of items, structural elements, compositional elements, and/or materials may be presented in a common list for convenience. However, these lists should be construed as though individual member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also all the individual numerical values or sub-ranges encompassed within that range as if individual numerical values and sub-ranges are explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

### Example 1—Preparation of Pre-treatment Compositions with Polymeric Particle Blends

Three examples of the pre-treatment composition disclosed herein were prepared that included a polymeric particle blend of polysiloxane particles, e.g., diamino-alkyl substituted dimethyl polysiloxane particles, and polyolefin release particles, e.g., high density polyethylene (HDPE) wax particles. The pre-treatment compositions also included other additives, including a pigment fixing agent and a small amount of surfactant. The three formulations are provided in Table 1, as follows:

TABLE 1
Pre-Treatment Compositions (PT1-PT3) with Polymeric Particle Blend

| | | PT1 | PT2 | PT3 |
|---|---|---|---|---|
| Component | Category | (Wt %) | (Wt %) | (Wt %) |
| WACKER ® HC 303 | *Polysiloxane Particles | 2.625 | 1.625 | 0.875 |
| LIQUILUBE ™ 405 | *Polyolefin Release Particles | 2 | 3 | 3.75 |
| Calcium Propionate | Fixer Compound | 0.1 | 0.1 | 0.1 |
| DYNWET ® 800 | Surfactant | 0.025 | 0.025 | 0.025 |
| Deionized Water | Solvent | ~95 | ~95 | ~95 |

| | | |
|---|---|---|
| Acetic Acid/NaOH | pH Adjuster | Adjust to pH 5-6 |

*Components of Polymeric Particle Blend
Weight Percentages Based on Active Component
WACKER ® HC 303 includes an emulsified diamino-alkyl substituted dimethyl polysiloxane particles,
available from Wacker Chemie AG (Germany).
LIQUILUBE ™ 405 wax is a HDPE Wax available from Lubrizol Corp. (USA).
DYNWET ® 800 is a surfactant or wetting agent available from BYK Chemie, Gmbh (Germany).

### Example 2—Preparation of Crosslinker Composition

An example crosslinker composition was prepared having the formulation shown in Table 2.

TABLE 2
Crosslinker Composition (XL1)

| Component | Category | Wt % |
|---|---|---|
| 2,2-dimethyl-1,3-propanediol | Organic Co-solvent | 4 |
| POLYCUP ™ 7350 | Azetidinium-containing Polymer | 4 |
| CRODAFOS ® N3A | Surfactant | 0.5 |
| Deionized Water | Solvent | Balance |

POLYCUP ™ 7350 includes a polyamine epichlorohydrin, available from Solenis LLC (USA).
CRODAFOS ® N3A is a surfactant, available from Croda International PLC (United Kingdom).

### Example 3—Preparation of White Ink Composition (W1)

An example white ink composition was prepared as shown in Table 3, as follows:

TABLE 3
White Ink Composition (W1)

| Specific Component | Active Ingredient Type | wt % |
|---|---|---|
| Titanium Dioxide | Pigment | 10 |
| Glycerol | Organic Co-solvent | 6 |
| LIPONIC ® EG-1 | Organic Co-solvent | 1 |
| CRODAFOS ® N3A | Surfactant | 0.5 |
| SURFYNOL ® 440 | Surfactant | 0.3 |
| ACTICIDE ® B20 | Antimicrobial agent | 0.2 |
| IMPRANIL ® DLN-SD | Polyurethane Binder | 6 |
| Deionized Water | Solvent | Balance |

5 wt % Potassium Hydroxide Aqueous Solution Added Until pH 8.5 Reached
Weight Percentages Based on Active Component.
LIPONIC ® EG-1 is available from Vantage Specialty Ingredients (USA).
CRODAFOS ® N3A is a surfactant available from Croda International PLC (United Kingdom).
SURFYNOL ® 440 is a nonionic surfactant, available from Evonik (Germany).
ACTICIDE ® B20 is an antimicrobial available from Thor Specialties, Inc. (USA).
IMPRANIL ® DLN-SD (Mw 133,000 Mw; Acid Number 5.2; Tg-47° C.; Melting Point 175-200° C.) is a polyurethane dispersion available from Covestro (Germany).

### Example 4—Fabric Hydrophobicity and White Opacity with Wash Cycling on Dark Fabric Substrates

Gildan black mid-weight 780 cotton T-shirts (having a basis weight of 180 gsm) were used as the fabric substrate substrates in the present example. More specifically, several black fabric substrate samples having an L* value between about 10 and 20 were individually pre-treated with pre-treatment compositions PT1-PT3 containing various ratios and wt % content of the two particles of the polymeric particle blends of the present disclosure. The pre-treatment composition was applied at around 60 grams per square meter (gsm) based on the weight of the pre-treatment composition formulation as a whole. Some variability of the weight basis was noted but were within about 5 gsm of one another. The pre-treatment coating compositions were applied to the black fabric substrates using padding technique where the fabrics were soaked in the pre-treatment composition solution for about a minute, and then the fabrics were squeegeed to remove excess pre-treatment liquid vehicle. The pre-treated fabrics were exposed to 120° C. using a hot air dryer, the fabric substrates prepared included a polymeric particle blend pre-treated on the fabric substrates.

After the pre-treated fabric substrates were prepared, example white prints were generated using the crosslinker composition (XL1) of Example 2 and the white ink composition (W1) of Example 3 by interleaving three layers of crosslinker with three layers of white ink, for a total of six layers. The crosslinker composition (XL1) was applied at from 6 dots per pixel (dpp) to 9 dpp per layer, and the white ink composition (W1) was applied at from 8 dpp to 14 dpp per layer. The prints were generated using a thermal inkjet printhead (6 passes) via wet on wet printing, e.g., W1 on XL1 while the crosslinker composition was still wet and then XL1 on W1 while the white ink composition was still wet, and so forth. XL1 and W1 were applied using an Innovator durability plot from an HP A3410 thermal inkjet pen. The black fabric substrates imaged with the white ink were then heat cured at 150° C. for 3 minute at 44 psi of pressure using a clam shell hot press. The printed fabric samples were then washed for 5 cycles using conventional washing machine at 40° C. with standard laundry detergent, air drying between cycles. The hydrophobicity of the fabric substrates and the L* values were measured at various stages during the wash cycling.

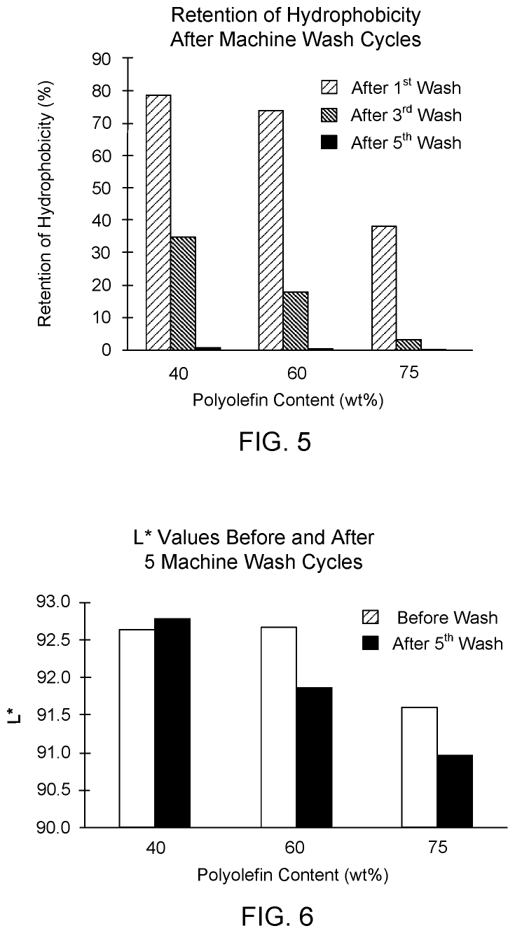

The data represented in FIG. 5 was collected to determine if the wash cycling would return the soft fabric feel of the fabric substrates after the fabric had become stiffened due to application of the polymeric particle blend, crosslinking compound, and white ink composition. The various samples had different concentrations of the polyolefin release compound content on the fabric substrate as well as polysiloxane particles, and also included different weight ratios of the same. It was verified that as few as a three washes significantly reduced the hydrophobicity of the fabric substrates, and the various fabric substrates started to regain their hand softness as a result. Fabric softness and hand feel were evaluated by touch comparison to untreated fabric. The hydrophobicity, on the other hand, was measured by dropping 10 μL of deionized water on the respective fabric surfaces positioned horizontally and in flattened configuration, and the time it took for the water drops to disappear a room temperature of 24° C. was recorded. The longer the time, the more hydrophobic the fabric substrate. The results were reported by averaging 5 measurements.

The data represented in FIG. 6 was collected to determine if the L* value could be retained to a reasonable degree, even though much of the polymeric particle blend content on the fabric substrate was removed during wash cycling (as evidenced by the significant reduction in hydrophobicity illustrated in FIG. 5). With respect to opacity values collected, a greater L* value indicates a higher opacity of the white ink on the colored fabric substrate. As can be seen, at 40 wt % polyolefin release particles in the polymeric particle blend formulation applied the fabric substrate, the L* value was very similar both before and after wash cycling 5 times, indicating good retention of white opacity on the black fabric substrate. At the other weight percentages of the polyolefin release particles (and thus corresponding reduced polysiloxane particle content), the reduction in L* values was much less significant than might have been expected based on the data related to reduction in hydrophobicity.

L* was measured in the CIELAB color space and may be measured using any suitable color measurement instrument (such as those available from HunterLab or X-Rite). The white ink composition, when printed on the colored fabric substrate pretreated with the pre-treatment composition and the crosslinker composition disclosed herein, may generate prints that have an L* value that is greater than prints generated on the same colored/dark fabric substrate with the same inkjet.

While several examples have been described in detail, it is to be understood that the disclosed examples may be modified. Therefore, the foregoing description is to be considered non-limiting.

What is claimed is:

1. A printable fabric medium, comprising:
a fabric substrate; and
a polymeric particle blend including polysiloxane particles and polyolefin release particles pre-treated on the fabric substrate, wherein a weight ratio of the polysiloxane particles to polyolefin release particles is from 1:5 to 4:1.

2. The printable fabric medium of claim 1, wherein the polysiloxane particles include an amino-functionalized polysiloxane, a polymethylhydrosiloxane, a hydromethyl polysiloxane, a dimethyl polysiloxane, a hydromethyl-dimethyl polysiloxane, a polyhexamethyl disiloxane, a polyecamethyl tetrasiloxane, a polydodecamethyl pentasiloxane, a polyoctamethyl trisiloxane, a polyoctamethyl cyclotetrasiloxane, a polydodecamethyl cyclohexasiloxane, a polydecamethyl cyclopentasiloxane, or a combination thereof.

3. The printable fabric medium of claim 1, wherein the polyolefin release particles include a polyethylene wax, a polypropylene wax, a copolymer of ethylene and propylene, a copolymer of ethylene and propylene with C4 to C8 alpha-olefin sidechains, or a combination thereof.

4. The printable fabric medium of claim 1, further comprising a fixer compound including an inorganic metal salt, an organic acid salt, an ionene salt, or a combination thereof.

5. The printable fabric medium of claim 1, wherein the fabric substrate is a dark fabric having an L* value from 0 to 50.

6. A textile printing system, comprising:
a fabric substrate;
a polymeric particle blend either pre-treated on the fabric substrate or contained in a pre-treatment composition applyable to the fabric substrate, wherein the polymeric particle blend includes polysiloxane particles and polyolefin release particles;
a crosslinker composition including a dispersion of a crosslinker compound; and
a white ink composition including a white pigment, a polymer binder, and an ink vehicle.

7. The textile printing system of claim 6, wherein the polysiloxane particles include an amino-functionalized polysiloxane, a polymethylhydrosiloxane, a hydromethyl polysiloxane, a dimethyl polysiloxane, a hydromethyl-dimethyl polysiloxane, a polyhexamethyl disiloxane, a polyecamethyl tetrasiloxane, a polydodecamethyl pentasiloxane, a polyoctamethyl trisiloxane, a polyoctamethyl cyclotetrasiloxane, a polydodecamethyl cyclohexasiloxane, a polydecamethyl cyclopentasiloxane, or a combination thereof.

8. The textile printing system of claim 6, wherein the polyolefin release particles include a polyethylene wax, a polypropylene wax, a copolymer of ethylene and propylene, a copolymer of ethylene and propylene with C4 to C8 alpha-olefin sidechains, or a combination thereof.

9. The textile printing system of claim 6, wherein the crosslinker compound comprises an azetidinium-containing polymeric salt.

10. The textile printing system of claim 6, wherein the white pigment includes titanium dioxide, zinc oxide, zirconium dioxide, cerium oxide, or a combination thereof, and the white pigment present in the white ink composition at from 4 wt % to 15 wt %.

11. The textile printing system of claim 6, wherein the fabric substrate is a dark fabric having an L* value from 0 to 50.

12. A textile printing method, comprising:
applying a crosslinker composition including a crosslinker compound to a fabric substrate that is pre-treated with a polymeric particle blend including polysiloxane particles and polyolefin release particles;
digitally printing a white ink composition on the fabric substrate in contact with the crosslinker composition and the polymeric particle blend, the white ink composition including a white pigment, a polymer binder, and an ink vehicle; and
thermally curing the fabric substrate with the polymeric particle blend, the crosslinker composition, and the white ink composition in contact thereon to form a cured white image on the fabric substrate.

13. The method of claim 12, wherein the polymeric particle blend is applied to the fabric substrate by applying a pre-treatment composition containing the polymeric particle blend to the fabric substrate, and wherein the pre-treatment composition is applied prior to application of the crosslinker composition and the white ink composition to the fabric substrate.

14. The method of claim 12, further comprising:
applying heat, pressure, or both to the pre-treatment composition on the fabric substrate prior to application of the crosslinker composition and the white ink composition;
applying heat, pressure, or both to the crosslinking composition on the fabric substrate prior to application of the white ink composition; or both.

15. The method of claim 12, wherein multiple alternating layers of the crosslinker composition and white ink composition are applied to the fabric substrate.
